(19) United States
(12) Patent Application Publication
(10) Pub. No.: US 2024/0144155 A1
(43) Pub. Date: May 2, 2024

(54) APPARATUS AND METHOD FOR LAWN FERTILIZING PRESCRIPTIVE SERVICES

(71) Applicant: Honda Motor Co., Ltd., Tokyo (JP)

(72) Inventor: Nathaniel LENFERT, Graham, NC (US)

(21) Appl. No.: 17/974,760

(22) Filed: Oct. 27, 2022

(51) Int. Cl. G06Q 10/08; G06Q 30/00

(52) U.S. Cl. CPC G06Q 10/083; G06Q 30/018

(57) ABSTRACT

A prescriptive lawncare apparatus, system, and method for fertilizing a property can include a user device that can determine or receive input related to a location of the property. The user device can access a database that includes regulations, such as government regulations, ordinances, bylaws, and the like related to authorized fertilizer products for a particular location. The user device and/or a server or controller can then compile and present to a user information related to authorized fertilizer products based on the regulations and location of the property. The user device can be associated with a lawncare machine or tool and can control the machine or tool to deploy or track application of fertilizer in a manner consistent with regulations.

### BACKGROUND

The disclosed subject matter relates to lawncare methods and apparatus. More particularly, the disclosed subject matter relates to methods and apparatus that can automatically select fertilizer for lawncare based on local regulations.

Many different fertilizers can be used to maintain and/or improve lawncare. The fertilizer can be selected based on the current health of the lawn, the soil content, price, ease of application on the lawn, etc. Each geographic area (city, county and state) can have ordinances and other regulations that govern the use of lawncare materials. In addition, local advice may exist for each geographic area that may be helpful to a property maintainer in providing best lawncare for his/her property. The ordinances and regulations can control the chemical make-up, amount and/or frequency of application of fertilizers for lawncare. In addition, other variables can be taken into account when selecting the type, amount, timing, and method of application of fertilizer.

Fertilizer can be applied to a lawn by many different methods. For example, a solid fertilizer can be spread by a dedicated vehicle such as a walk-behind wheeled spreader. In another example, fertilizer can be mixed with water and manually sprayed onto the lawn by the property maintainer. In another example, fertilizer can be mixed with water in a portable tank that can be pushed by the property maintainer or towed behind a vehicle such as, but not limited to, a garden tractor or an all-terrain vehicle.

Manual tools, manually operated machines, powered tools and powered machines can be used to create and maintain a landscape for a residential property or a commercial property. The manual tools and machines can be referred to collectively as manual equipment and include, but are not limited to, a rake, a shovel, a hoe, an aerator, pruning shears, a pruning saw, and a lawnmower. The powered tools and powered machines can be driven by an internal combustion engine or an electric motor or a hybrid of an internal combustion engine and an electric motor. The powered tools and machines can be referred to collectively as powered equipment or power equipment and include, but are not limited to, a string trimmer, a hedge trimmer, a power saw, a lawnmower, a tiller, a snowblower, and a garden tractor.

Residential property owners, property managers and commercial property owners can manage the care of the lawn and other vegetation forming the landscape of the property on their own or through a professional landscape service or both. Do-it-yourself (“DIY”) lawncare can require the property maintainer to invest in the purchase of any number of manual equipment and/or powered equipment. DIY lawncare can also require a substantial amount of time to perform the various tasks/duties required to achieve the desire aesthetics for the landscape of the property. Further, DIY lawncare can require the property maintainer to preform repairs and preventative maintenance on the manual equipment and/or the powered equipment. The property maintainer can perceive the repair and maintenance activities as an inconvenience or an undesirable obstacle for maintaining the desired aesthetics of the landscape.

As an alternative to DIY lawncare, a property maintainer can employ the services of a professional landscaper to maintain the health and appearance of vegetation on the property at the desired level of aesthetics. A professional landscape service can have access to a wide variety of manual equipment and powered equipment that can permit the professional landscaper to execute the desired lawncare treatment more effectively and/or efficiently than the property owner. However, the cost of the professional landscape services can outweigh the convenience to the property owner.

### SUMMARY

Some embodiments are directed to an automated system for delivering fertilizer to a property that can include at least one of a lawncare machine and lawncare tool including a cargo space configured to deliver fertilizer to the property, and a controller configured to, communicate with a database that includes regulations related to fertilizer and associated with a location of the property, present to a user a list of authorized fertilizer products based on the location of the property and the regulations

Some embodiments are directed to a method for fertilizing a property that can include providing a user device that includes a graphic user interface, at least one of determining and inputting, via the user device, a location of the property, accessing, via the user device, a database that includes regulations related to fertilizer and associated with the location of the property, compiling and presenting to a user, via the user device, information related to authorized fertilizer products based on the regulations and location of the property.

Some embodiments are directed to a system to assess lawn fertilizer conditions at a location, the system including a tangibly embodied computer processor (CP) and a tangibly embodied database, the CP implementing instructions on a non-transitory computer medium disposed in the database, and the database in communication with the CP. The system can include a communication portion for providing communication between the CP and a user device, the database that includes the non-transitory computer medium, and the database including the instructions, and the database storing advice/regulation data regarding fertilizer, a location sensor that generates sensor location data based on physical location, and the CP, and the CP performing processing including: determining that a first sample event has been attained; inputting, based on the determining that the first sample event has been attained, first sample data relating to a first sample, and the first sample data including first location data and first advice/regulation data, (a) the first location data representing where the first sample was taken, and, (b) the first advice/regulation data including information related to fertilizer, the first location data is part of the sensor location data, and the information related to fertilizer is part of the advice/regulation data, identifying, based on the first location data, information related to fertilizer associated with the first location data; and applying the information related to fertilizer associated with the first location data to an operation for the location.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which

FIG. 1 is a prescriptive lawncare system made in accordance with principles of the disclosed subject matter.

FIG. 2A is flowchart that outlines the general operation of the prescriptive lawncare treatment system of FIG. 1 in accordance with principles of the disclosed subject matter.

FIG. 2B is a schematic view of an automated system for delivering fertilizer to a property made in accordance with principles of the disclosed subject matter.

FIG. 3 is a block diagram and schematic depicting a prescriptive lawncare system made in accordance with principles of the disclosed subject matter.

FIG. 4 is a flow chart showing details of an prescriptive lawncare system, in accordance with principles of the disclosed subject matter.

FIG. 5 is a flowchart showing processing that can be performed by the prescriptive lawncare system.

FIG. 6 is a flowchart showing processing that can be performed by the prescriptive lawncare system.

FIG. 7 is a flowchart showing processing that can be performed by the prescriptive lawncare system.

FIG. 8 is a schematic view of an exemplary graphic user interface and device for use in the prescriptive lawncare system.

FIG. 9 is a schematic view of an exemplary graphic user interface and device for use in the prescriptive lawncare system.

FIG. 10 is a schematic diagram of a location database for use in the prescriptive lawncare system.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

A residential property or a business property can include a lawn or turf on the property that can be maintained in a manner that compliments the aesthetics of the building(s) and other landscaping features of the property. Fertilizing the lawn or turf can be an important aspect for maintaining the aesthetic contribution of the lawn or turf. Fertilizers can be in granular, solid, or liquid form and possibly even gaseous form, and can include chemicals, herbicides, soil amendments, nutrients, polymer coated substances, proteins, amino acids, organic acids, volatile organic compounds (VOCs), fulvic acids, natural bacteria, water, seeds, etc. Specifically, fertilizers can include nitrogen, sulfur, potassium, phosphorous, boron, magnesium, molybdenum, chlorine, copper, zinc, iron, lime, dithiopyr, prodiamine, atrazine, gypsum, humic, calcium, and other known chemicals, chemical compounds, and organic materials that enhance and encourage lawn growth and health.

Government ordinances and regulations can vary from one geographic area to another. A property owner, or renter, or maintainer of the property (collectively hereinafter referred to as property maintainer) might not be familiar with all of the ordinances and/or regulations that govern the use of fertilizer on the property. Thus, it can be advantageous for a person or entity that cares for and maintains a lawn or turf to rely on an automated system that can indicate which fertilizer(s) are recommended and/or permitted by local, state and federal regulations and by what method(s) or how frequently the permitted fertilizer(s) can be applied to the lawn or turf. The automated system can be configured to permit the user to select the desired fertilizer(s) from a list of fertilizers permitted for the geographic area in which the lawn or turf is located. The address of the target property can be input by the property maintainer into a device such as phone, computer, tablet, dashboard, screen, or any other known graphic user interface (GUI) associated with the user device 131. Alternatively, a GPS or other locating system can be incorporated or associated with the user device 131 to provide location data. The automated system 10 can be configured to automatically deliver the selected fertilizer(s) to the property. The automated system 10 can also be configured to automatically apply the selected fertilizer(s) to the property and record all fertilizing activity for future reference.

Using the system 10, a property maintainer can select from a list of issues such as lack of nutrients, disease, damage, discoloration, and other apparent defects in the lawn or turf. Then, using the location (either sensed or input) the system 10 can access a government or private database, and the system 10 can then recommend products (off the shelf or otherwise) that are allowed and/or recommended and can provide instructions on how to use the products by text or video or other means of communication. In addition, a custom mixture of product can be provided (delivered to or mixed at location), that can minimize environmental impact and cost. The custom mixture could also automatically be created and shipped directly to the property maintainer.

In addition to routine cutting, trimming, and pruning the vegetation that forms a property landscape, other maintenance of the landscape can include watering, fertilizing, seeding, aeration and/or dethatching. A property maintainer can completely lack experience in basic lawncare or have very limited experience with lawncare. Further, a property maintainer can completely lack or have only a basic understanding for diagnosing the health of the property's landscape and/or how to effect treatment of the landscape to improve or maintain the health of the landscape. Thus, there is a need for a prescriptive lawncare service that can help a property maintainer to diagnose the current health of the property's landscape, maintain the health, modify the landscape to improve appearance and/or achieve the desired aesthetics, apply authorized fertilizer ingredients, and perform routine maintenance such as but not limited to cutting of the lawn.

The system 10 can use over-the-air firmware to stay updated and can include a central data repository that is either built into the user device 131 or accessible, for example, via Wi-Fi, Bluetooth, cellular, satellite, other connection, to the user device 131.

The system 10 can be configured to determine whether a particular proposed application of fertilizer is illegal or not recommended and initiate a warning communication via the user device 131 such as initiating a sound or message through the speaker(s) 133, or visual message via a graphic user interface 302 which can take the form of a display monitor or the like. The system 10 can also be incorporated into the supply chain of an existing fertilizer business model. Security protocols can be implemented to protect data communicated throughout the system 10. The system 10 can include software or hardware configured to access or scan government regulations, laws, and/or ordinances or advice type documents or information. If the system 10 detects addition of regulations, laws, advice, and/or ordinances, the system 10 can raise a flag such as visual or oral warning to ensure the property maintainer is aware of new regulations, laws, advice, and/or ordinances. The system 10 can also include incentives for complying with regulations, laws, advice, and/or ordinances. For example, product discounts can be communicated or provided to the user of the system 10 after proper fertilization is ordered and/or completed. The system 10 can monitor whether certain parts per fertilizer are legal or in compliance with advice or regulations, etc. The system 10 can also be used to calculate or recommend amounts of fertilizer over square footage. Further, the system 10 can be configured to use GPS or other location information to determine or calculate how much fertilizer has been distributed to different areas. Thus, the system 10 can also be configured to measure, track and limit the application rate (over time and amount of materials) to the lawn or turf. The system 10 can also be an active means for preventing run off, improving water quality at the property and in the surrounding community, improving the ecosystem and bodies of water, and managing algae growth in the surrounding community water.

The system 10 can also take into count variables, such as whether rain has occurred or is predicted, in its prescriptive processes. Thus, the system 10 can recommend fertilizer timing and/or prevent fertilizing at a wrong time. The system 10 could be configured to lock up (prevent distribution of fertilizer) if certain variables are present, such as drought, flooding, seasonal/timing issues, temperature issues, cloudiness issues, etc.

The system 10 could also be configured to allow for policing or enforcement of regulations, ordinances, etc., either by government officials or property owners. Thus, an owner of the system 10 can provide a type of certification to its customers (or regulators) that it complies with local ordinances, regulations, or advice when fertilizing properties. The system 10 can also be utilized to provide a national database of those that are getting certain fertilizers, and who is certified under the system 10.

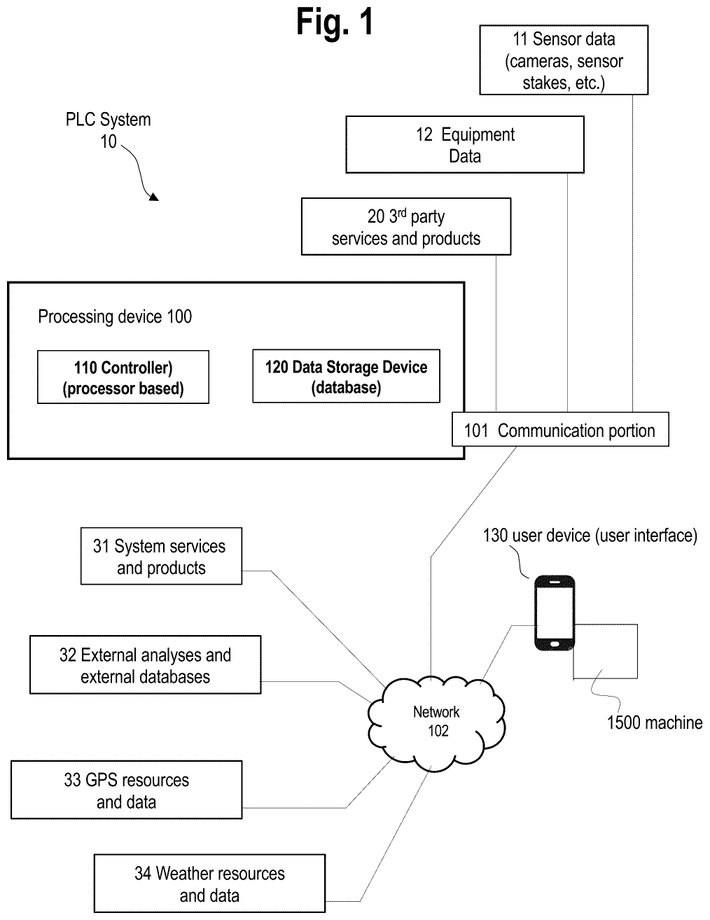

FIG. 1 is a schematic illustration of a prescriptive lawncare system (“PLC system”) 10 that can provide a property maintainer with information about a relevant landscape, formulate a treatment plan for the landscape, recommend service(s) and equipment for executing the treatment plan, and/or provide instructions for executing the treatment plan. The PLC system 10 can include data processing device or system 100 (hereinafter “processing device 100”), sensor data 11, equipment data 12, and other processing and/or data resources. The PLC system 10 can include third party services and systems/products 20 that can include external services and systems. The PLC system 10 can include system services and products 31, external analyses and external database resources 32, global positioning satellite (“GPS”) resources and data 33, and weather resources and data 34.

The processing device 100 can include a communication portion 101, a processor-based controller 110, and a data storage device 120.

The communication portion 101 can be electrically connected and in communication with the various components of the PLC system 10, as shown in FIG. 1. Such electrical connection and communication can be provided over a network 102 or over some other communication mechanism or arrangement.

FIG. 1 schematically illustrates respective lines or communication lines connecting the communication portion 101 to each of the data inputs 11, 12, the providers 20, 31, 32, 33, 34, and the user interface 130. These lines can schematically represent a wired connection or a wireless connection. The electrical communication can be over a local computer network, or over the internet, or over a cellular network, or any combination these networks or over some other communication mechanism. The electrical communication can be over network 102, as shown in FIG. 1. The communication portion 101 can pass data and/or information between the controller and each of the data inputs 11, 12, the providers 20, 31, 32, 33, 34, and the user interface 130.

The sensor data 11 can include data indicative of the color and density of a lawn, the moisture content, sunlight exposure, and other attributes. The sensor data 11 can be obtained by any appropriate device(s) such as but not limited to a camera, sensor stakes, etc.

The equipment data 12 can include the type of lawncare equipment that is owned by the property maintainer, the type lawncare equipment owned by one or more neighbors, and/or the type of lawncare equipment being used on the property or location by a professional landscape service. The equipment data can include data indicative of handheld tools, walk-behind machines, and ride-on machines. The equipment data can include attributes of the equipment including whether the equipment is manually operated, powered by an internal combustion engine, powered by an electric motor, or powered by a hybrid of an internal combustion engine and electric motor. The equipment data can include data indicative of the hours of operation, the maintenance schedule, completed maintenance, etc., for each piece of equipment.

The user interface can be in the form of a user device 131. The user interface can be any appropriate electronic device, such as, but not limited to, a cellular (mobile) telephone, a tablet computer, a laptop computer, a desktop computer, a server terminal, that can permit a user to input requests for information to and receive information generated by the processing device 100. A first user device 131 can be built into or associated with a machine 1500 or tool 1510, such as a lawnmower, fertilizer spreader, tractor, ATV, vehicle, weed trimmer, cutting tools, and other lawncare implements. The machine 1500 or tool 1510 can include a cargo space 1520 that is configured to carry and distribute fertilizer. The system 10 can include a second user device 132 configured similar to or different from the first user device 131 as a machine 1530 or tool 1540, and which also can include a cargo space 1520 that is configured to carry and distribute fertilizer. The first user device 131 second user device 132 can communicate with each other via network 102 to compile data related to lawncare, such as amount and location of fertilizer applied by a respective device 131, 132.

The GPS resources and data 33 can include satellite image(s) of the property and neighboring properties, street level image(s) of the property and neighboring properties. map data of the property and neighboring properties, and address information of the property and neighboring properties. Any number of user interfaces 130 can be in electrical communication with the processing device 100.

The weather resources and data 34 can include data indicative of temperature (daily highs and lows, averages, maximums, minimums, current) precipitation amounts, amount of sunshine (average, maximums, minimums, current). The weather data 34 can be obtained from a service provider or government agency.

One or more sensors 1570 can be located in any of the user device(s) 130, 131, 132 and/or can be located in the machines and tools, 1500, 1510, 1530, 1540 and/or can be located separate from the user devices, machines and tools and configured to communicate with any one or more of the machines, tools, user devices, and server 100. The sensors 1570 can be any known type of sensor that is capable of obtaining any of the types of data used by the system 10. For example, the sensors 1570 can include a Global Positioning System (GPS) location sensor, a temperature sensor, a pH sensor, a moisture sensor, chemical or gas chromatography sensor, a sunlight sensor, wind sensor, humidity sensor, or any other sensor known for use in lawncare and maintenance.

In general, inputs into the processing device 100 can be electrically connected to data sources such as, but not limited to, a soil sample analysis, geographic information, lawn scan and mapping data, and regulation/ordinance information. Data representing soil sample analysis can be provided by a third party or determined by the controller 110 using data output by a soil analysis apparatus in electrical communication with the controller 110, where the output data is based on a soil sample introduced to an analysis apparatus by the user. Lawn scan and mapping data can be based on data obtained from, but not limited to, a formal land survey, satellite imagery, a digital image scan of the landscape, and government agency(ies) such as the U.S. Geological Survey and U.S. Department of Agriculture. Regulation/ordinance information can be obtained from any appropriate local, regional or national government agency or from a subscription database of local, regional and national regulations and ordinances.

The processing device 100 can generate outputs, through electrical communication, to the user interface 130 and the service and/or equipment providers. The processing device 100 can output a treatment plan and/or other information requested by the user and can output requests or notifications to the service and/or equipment providers based on the treatment plan and/or other information requested by the user.

The processor-based controller (“controller”) 110 can be a physically embodiment of a machine referred to as an electronic computing device such as but limited to an electronic control unit (“ECU”), a central processing unit (“CPU”), a microcontroller, a microcomputer, a server, a plurality of electronic computing devices or servers, or other appropriate processor-based controller(s) that can receive data inputs, execute commands for processing the data inputs, and output a treatment plan based on executed commands. The controller 110 can be configured with hardware alone or in combination with software to execute commands that process the data inputs and output any of a plurality of lawncare treatment plans in accordance with the disclosed subject matter. The controller 110 can be referred to as a product and service recommendation engine 110.

For example, the controller 110 can be configured to interact with the user interface 130 and permit a user to request a fertilizer plan for the landscape. The controller 110 can be configured to determine a fertilizer content and schedule based on data input by the user and data input from any appropriate data input(s). In another example, the controller 110 can be configured to permit the user to request a sunlight evaluation of the landscape based on measured sunlight data input to the controller 110 and recommend a treatment plan for the landscape based on the processed sunlight data. In yet another example, the controller 110 can be configured to permit the user to request an evaluation of the grade of the lawn and output a recommended adjustment of the grade and provide the user with instructions and recommendations on how to achieve the recommended grade. In yet another example, the controller 110 can be configured to permit the user to request a soil analysis of the landscape, recommend a treatment plan for the landscape soil, and provide a water run-off analysis after the user implements the treatment plan. In yet another example, the controller 110 can be configured to permit the user to select a desired aesthetic appearance of the landscape, recommend a treatment plan that can achieve the desired aesthetic appearance, and rank the recommended treatment plan according to predetermined parameters such as but not limited to difficulty, cost, equipment availability. The controller 110 can be in electrical communication with each of the data inputs 11, 12, the providers 20, 31, 32, 33, 34, and the user interface 130.

The data storage device 120 can be any appropriate non-transitory recording or storage medium such as, but not limited to, a CD-ROM, a DVD-ROM, a hard drive, a RAM, a ROM, a floppy disc, and a magnetic tape cassette, or later developed medium such as, but not limited to, transitory recording medium, or carrier waves. The data storage device 120 can include some or all of the software that is executed by the controller 110 in order to provide the treatment plan(s) requested by the user. The data storage device 120 can store data created by the controller 110 that is indicative of the one or more parameters of a landscape, lawn or location such as, but not limited to, grade, type(s) and location(s) of the vegetation, water-run-off analysis, scanned images, map information, soil analysis, coloration of the vegetation, chemical analysis of the vegetation. These parameters can be referred to as the digital lawn.

A provider of the PLC system 10 can be a manufacturer of lawncare equipment. The system services and products 31 can include lawncare products manufactured by the manufacturer, other service(s) on offer by the manufacture and other products available from the manufacturer. The processing device 100 can communicate with the system services and products 31 to provide the user with suggested equipment, sales information, and other services/products. The sales information can include the location of a lessor, retailer or dealer of the suggested equipment. The controller 110 can be configured to send a message to the lessor, retailer or dealer indicative of the user's desire of or inquiry regarding the suggested equipment so that the lessor, retailer or dealer can initiate contact with the user about a possible sale or lease of the suggested lawncare equipment.

The manufacturer of lawncare equipment and provider of the PLC system 10 can also offer other services such as, but not limited to, professional landscaping, professional lawncare maintenance, and other products such as, but not limited to, portable generators, cars, pick-ups, sports-utility vehicle, cross-over vehicle, vans, motorcycles, all-terrain vehicle, outboard motors, and aircraft. The controller 110 can be configured to provide the user with information regarding any of the other products or offerings from the manufacture.

The external services and products 20 can be any third party entity not affiliated with the provider of the PLC system 10 such as, but not limited to, a manufacturer of fertilizer, a professional landscaper, or a rental company that leases lawncare equipment. The controller 110 can be configured to provide the user and any component of the external services and products 20 with information about each other. For example, the controller 110 can be configured to output a message to a professional landscaper that indicates that the user is interested in hiring a professional landscaper. The controller 110 can be configured to obtain information from the landscaper such as cost, services provided and equipment used and provided this information to the user via the user interface or user device 131. For example, the landscaper can have traditional lawncare equipment that is operated by a designated person, or automated lawncare equipment that is operated remotely or fully autonomous.

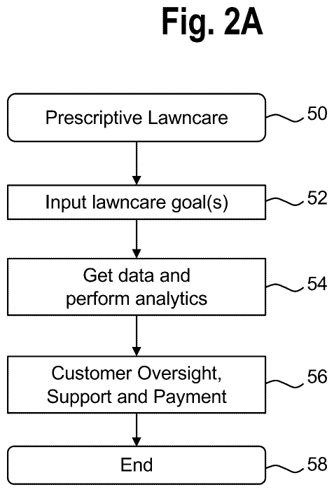

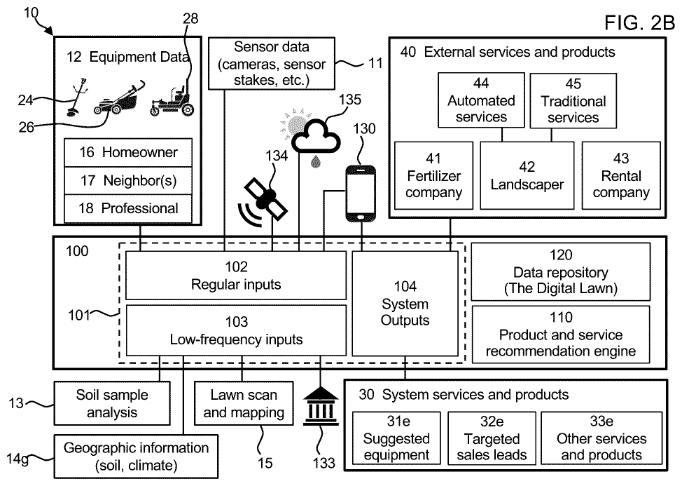

FIG. 2 is flowchart illustrating the general operation of the controller 110. At step 50, the user can initiate a prescriptive lawncare service session with the controller 110 via the user interface 130. The processing performed by the controller 110 can then move to step 52.

At step 52, the controller 110 can be configured to prompt the user to input one or more lawncare goals for the property or location. The controller 110 can be configured to move to step 54 when the user has entered desired goals to the controller 110 via the user interface 130.

At step 54, the controller 110 can be configured to access all of the data inputs 11, 12, the providers 20, 31, 32, 33, 34, and the user interface 130, that are appropriate to generate a treatment plan in accordance with the user's goal(s). After obtaining the data, the controller 110 can be configured to analyze the obtained data in accordance with predetermined processing, computations and comparisons. After completing the analysis, the controller 110 can move to step 56.

At step 56, the controller 110 can be configured to generate and output a treatment plan based on the analysis performed in step 54. The controller 110 can be configured to prompt the user to request or decline supplemental information regarding the treatment plan. The supplemental information can include information from the system services and products 30, information from the external services and products 40, instructions on how to execute the treatment plan, frequently asked questions (“FAQs”) related to the treatment plan, etc. At step 56, the controller 110 can be configured to accept payment from the user for the treatment plan and for any services and products ordered for the execution of the treatment plan.

After completing the payment(s), the controller 110 can be configured to end the prescriptive lawncare service session.

As an example of the execution of the flowchart of FIG. 2, the user can select a set a specific goal of the lawn at step 52 that indicates a lush, thick grass lawn. The controller 110 can execute one or more subroutines at step 54 that are predetermined for use in generating a treatment plan directed toward a lush, thick lawn. The subroutine(s) executed at step 54 can include steps to obtain data regarding the type of grass on the property, historical rainfall and temperature data for the property, grade of the lawn on property, historical sunlight data from the property, and soil analysis data for the property, and ordinances and regulations regarding chemical treatments to land in the jurisdiction of the property. The controller 110 can output a treatment plan at step 56 that includes the application of fertilizer and a list of chemical(s) that are permitted by ordinance/regulation for the property. and retailers of the permitted chemical(s). The controller 110 can be configured to prompt for and accept payment for the treatment plan and any chemical(s) order using the PLC system 10.

FIG. 1 shows an exemplary automated system 10 that can include a fertilizer source 12, a controller 14 and a vehicle 16. The fertilizer source 10 can be a manufacturer, a distributor, a wholesaler, a retailer, a co-operative or any other authorized or licensed seller of fertilizer. The controller 14 can be a general purpose computer, a mobile tablet, a smart phone, or other electronic device through which a user can select and order a fertilizer product. The vehicle 16 can be any type of vehicle such as a delivery truck that is driven by a person, a fully autonomous vehicle, or a semi-autonomous vehicle.

FIG. 1 shows a residential property RP that can be located in a first city, a first county and a first state and a business property BP in the first county and first state, but outside of the first city. Each of the first city, the first county and the first state can have ordinances, rules and regulations that control the chemical composition and the amount of the chemical composition that can be applied to the residential property RP that is located in the first city, the first county and the first state. The ordinances, rules and regulations can be referred to collectively as regulations. The regulations of each jurisdiction can be different from each other, or the same as each other, or some of the regulations can be the same and other regulations can be different from each other. For example, the regulations for the first county can be the same as the regulations for the first state, and at least one regulations for the first city can be different from those if the first county and the first state. Further, the regulations for the business property BP can be different for residential property RP in a given jurisdiction.

The controller 14 can be referred to as an electronic can be referred to as an electronic control unit (“ECU”) or a central processing unit (“CPU”). The controller 14 can include a processor or a microprocessor, a read-only memory device (“ROM” or “EEPROM”), and a random access memory device (RAM). The controller 14 can be configured with hardware, with or without software, to perform the assigned task(s). The controller 14 can include a transceiver for wireless communication with a network and the internet and a communication port for wired communication with the network and the internet. A different controller 14′ can be used in the business property BP. The different controller 14′ can be configured in any manner described above with respect to the controller 14 and can operate in a manner that is the same as or similar to the operations of the controller described herein.

The controller 14 can include a built-in display and/or be connected be connected to an external display. When connected to an external display, the controller 14 can be configured to communicate with the display through a wired connection or a wireless connection. The built-in display and the external display can be a touch screen display, a liquid crystal display (“LCD”), or any other appropriate display that can present information to a user of the controller 14.

The automated system 10 can include a regulation database 18. The regulation database 18 can include data indicative of the authorized fertilizer chemical(s) for each jurisdiction of a relevant country or union of countries.

The fertilizer source 12, the controller 14, and the regulation database can be connected to each other over the internet 20.

FIG. 2B is a schematic illustration of a prescriptive lawncare system (“PLC system”) 10 that can provide property owners/managers and professional landscapers with information about a relevant landscape, formulate a treatment plan for the landscape, recommend service(s) and equipment for executing the treatment plan, and/or provide instructions for executing the treatment plan. The PLC system 10 can include data processing device or system 100 (hereinafter “processing device 100”), sensor data 11, equipment data 12, soil sample analysis 13, geographic information 14g, lawn scan and mapping data 15, system services and products 30, external services and products 40, a user interface 130, regulation and ordinance data 133, global positioning satellite (“GPS”) data 134, weather data 135.

The processing device 100 can include a communication portion 101, a processor-based controller 110, and a data storage device 120.

The communication portion 101 can be electrically connected to a plurality of data inputs 11, 12, 13, 14g, 15, 133, 134, 135, a plurality of equipment and/or service providers 30, 40, a user interface 130. FIG. 1 schematically illustrates a line connecting the communication portion 101 to each of the data inputs 11, 12, 13, 14, 15, 133. 134, 135, the providers 30, 40, the user interface 130. These lines can schematically represent a wired connection or a wireless connection. The electrical communication can be over a local computer network, or over the internet, or over a cellular network, or any combination these networks. The communication portion 101 can pass data and/or information between the controller and each of the data inputs 11, 12, 13, 14, 15, 133. 134, 135, the providers 30, 40, the user interface 130.

The communication portion 101 can include a plurality of regular inputs 102, a plurality of low-frequency inputs 103 and a plurality of system outputs 104. The regular inputs can be in electrical communication with sensor data 11, equipment data 12, a user interface 130, GPS data 134, weather data 134.

The sensor data 11 can include data indicative of the color and density of the lawn, the moisture content, sunlight exposure, etc. The sensor data 11 can be obtained by any appropriate device(s) such as but not limited to a camera, sensor stakes, etc.

The equipment data 12 include the type of lawncare equipment 16 that is owned by the property owner/manager, the type lawncare equipment 17 owned one or more neighbors, the type of lawncare equipment 18 being used on the property by a professional landscape service. The equipment data can include data indicative of handheld tools 24, walk-behind machines 26, and ride-on machines 28 and whether the equipment is manually operated, powered by an internal combustion engine, powered by an electric motor, or powered by a hybrid of an internal combustion engine and electric motor. The equipment data can 12 include data indicative of the hours of operation, the maintenance schedule, completed maintenance, etc., for each piece of equipment.

The user interface 130 can be any appropriate electronic device, such as, but not limited to, a cellular (mobile) telephone, a tablet computer, a laptop computer, a desktop computer, a server terminal, that can permit a user to input requests for information to and receive information generated by the processing device 100.

The GPS data 134 can include satellite image(s) of the property and neighboring properties, street level image(s) of the property and neighboring properties. map data of the property and neighboring properties, and address information of the property and neighboring properties. Any number of user interfaces 130 can be in electrical communication with the processing device 100.

The weather data 135 can include data indicative of temperature (daily highs and lows, averages, maximums, minimums, current) precipitation amounts, amount of sunshine (average, maximums, minimums, current). The weather data 135 can be obtained from a service provider or government agency.

The low-frequency inputs 103 can be electrically connected to data sources such as, but not limited to, a soil sample analysis 13, geographic information 14, lawn scan and mapping data 15, and regulation/ordinance information 133. The data representing the soil sample analysis 15 can be provided by a third party or determined by the controller 110 using data output by a soil analysis apparatus in electrical communication with the controller 110, where the output data is based on a soil sample introduced to the analysis apparatus by the user. The lawn scan and mapping data 15 can be based on data obtained from, but not limited to, a formal land survey, satellite imagery, a digital image scan of the landscape, and government agency(ies) such as the U.S. Geological Survey and U.S. Department of Agriculture. The regulation/ordinance information 133 can be obtained from any appropriate local, regional or national government agency or from a subscription database of local, regional and national regulations and ordinances.

The system outputs 104 can be in electrical communication with the user interface 130 and the service and/or equipment providers 30, 40. The system outputs 104 can output a treatment plan and/or other information requested by the user and can output requests or notifications to the service and/or equipment providers 30, 40 based on the treatment plan and/or other information requested by the user.

The processor-based controller (“controller”) 110 can be a physically embodiment of a machine referred to as an electronic computing device such as but limited to an electronic control unit (“ECU”), a central processing unit (“CPU”), a microcontroller, a microcomputer, a server, a plurality of electronic computing devices or servers, or other appropriate processor-based controller(s) that can receive data inputs, execute commands for processing the data inputs, and output a treatment plan based on the executed commands. The controller 110 can be configured with hardware alone or in combination with software to execute commands that process the data inputs and output any of a plurality of lawncare treatment plans in accordance with the disclosed subject matter. The controller 110 can be referred to as a product and service recommendation engine.

For example, the controller 110 can be configured to interact with the user interface 130 and permit the user to request a fertilizer plan for the landscape. The controller 110 can be configured to determine a fertilizer content and schedule based on data input by the user and data input from any appropriate one(s) of the data inputs 11, 12, 13, 14, 15, 133. 134, 135. In another example, the controller 110 can be configured to permit the user to request a sunlight evaluation of the landscape based on measured sunlight data input to the controller 110 and recommend a treatment plan for the landscape based on the processed sunlight data. In yet another example, the controller 110 can be configured to permit the user to request an evaluation of the grade of the lawn and output a recommended an adjustment of the grade and provide the user with instructions and recommendations on how to achieve the recommended grade. In yet another example, the controller 110 can be configured to permit the user to request a soil analysis of the landscape, recommend a treatment plan for the landscape soil, and provide a water run-off analysis after the user implements the treatment plan. In yet another example, the controller 110 can be configured to permit the user to select a desired aesthetic appearance of the landscape, recommend a treatment plan that can achieve the desired aesthetic appearance, and rank the recommended treatment plan according to predetermined parameters such as but not limited to difficulty, cost, equipment availability. The controller 110 can be in electrical communication with the inputs 102, 103, the outputs 104 and the data storage device 120.

The data storage device 120 can be any appropriate non-transitory recording or storage medium such as, but not limited to, a CD-ROM, a DVD-ROM, a hard drive, a RAM, a ROM, a floppy disc, and a magnetic tape cassette, or later developed medium such as, but not limited to, transitory recording medium, or carrier waves. The data storage device 120 can include the some or all of the software that is executed by the controller 110 in order to provide the treatment plan(s) requested by the user. The data storage device 120 can store data created by the controller 110 that is indicative of the one or more parameters of the landscape such as, but not limited to, grade, type(s) and location(s) of the vegetation, water-run-off analysis, scanned images, map information, soil analysis, coloration of the vegetation, chemical analysis of the vegetation. These parameters can be referred to as the digital lawn.

The provider of the PLC system 10 can be a manufacturer of lawncare equipment. The system services and products 30 can include lawncare products manufactured by the manufacturer, other service(s) on offer by the manufacture and other products available from the manufacturer. The processing device 100 can communicate with the system services and products 30 to provide the user with suggested equipment 31, sales information 32, other services/products 33. The sales information can include the location of a lessor, retailer or dealer of the suggested equipment. The controller 110 can be configured to send a message to the lessor, retailer or dealer indicative of the user's desire of or inquiry regarding the suggested equipment so that the lessor, retailer or dealer can initiate contact with the user about a possible sale or lease of the suggested lawncare equipment.

The manufacturer of lawncare equipment and provider of the PLC system 10 can also offer other services such as, but not limited to, professional landscaping, professional lawncare maintenance, and other products such as, but not limited to, portable generators, cars, pick-ups, sports-utility vehicle, cross-over vehicle, vans, motorcycles, all-terrain vehicle, outboard motors, and aircraft. The controller 110 can be configured to provide the user with information regarding any of the other products on offer from the manufacture.

The external services and products 40 can be any third party entity not affiliated with the provider of the PLC system 10 such as, but not limited to, a manufacturer 41 of fertilizer, a professional landscaper 42, or a rental company 43 that leases lawncare equipment. The controller 110 can be configured to provide the user and any of component of the external services and products 40 with information about each other. For example, the controller 110 can be configured to output a message to a professional landscaper that indicates that the user is interested in hiring a professional landscaper. The controller 110 can be configured to obtain information from the landscaper 42 such as cost, services provided and equipment used and provided this information to the user via the user interface 130. For example, the landscaper can have traditional lawncare equipment 45 that is operated by a designated person, or automated lawncare equipment 44 that is operated remotely or fully autonomous.

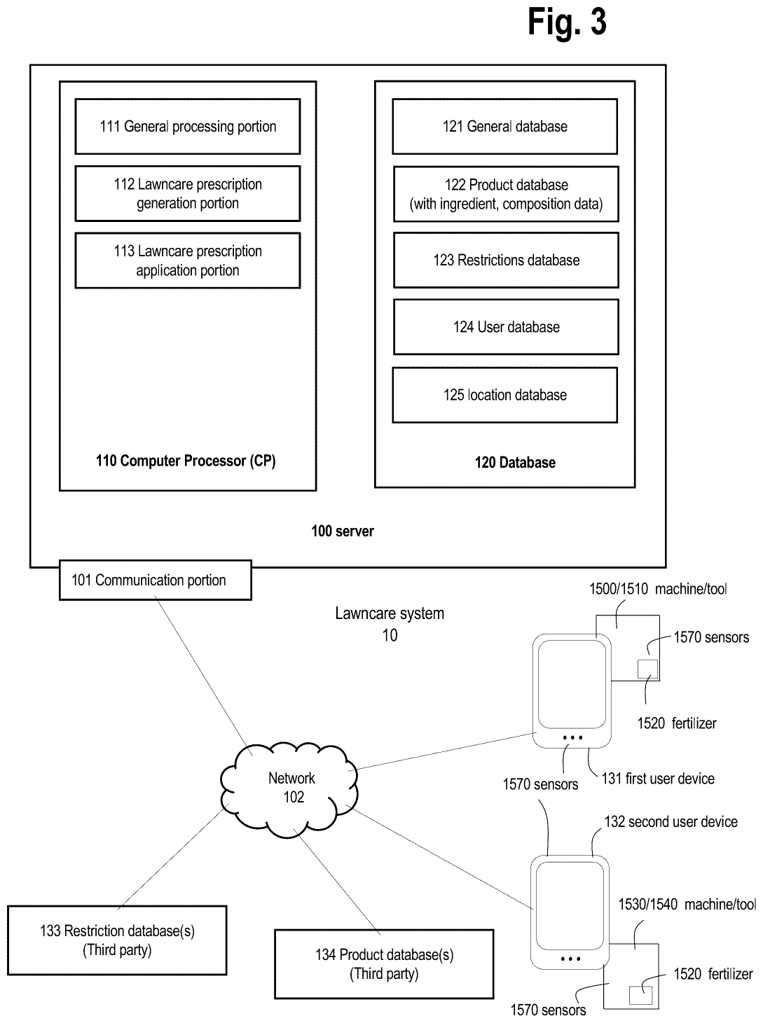

FIG. 3 is a schematic diagram showing details of a lawncare system 10, in accordance with principles of the disclosed subject matter. The lawncare system 10 can include a server or other processing device 100. The lawncare system 10 can include a computer processor (CP) 110 and a database 120. The CP 110 can perform various processing to provide the features and functionality as described herein. The CP 110 can include a general processing portion 111. The general processing portion 111 can provide various general processing of the lawncare system 10 including data maintenance, security related processing, and other general processing not handled by specialized processing portions of the device 100.

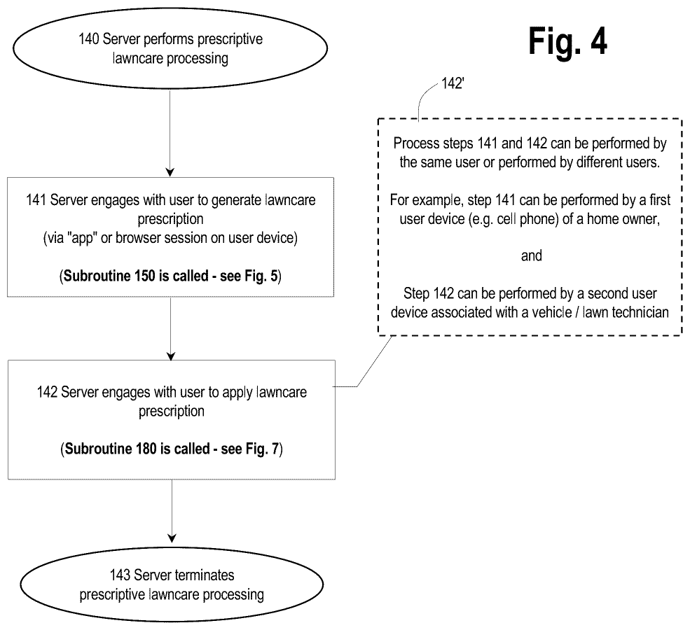

The CP 110 can also include a lawncare prescription generation portion 112 and a lawncare prescription application portion 113. The lawncare prescription generation portion 112 can perform various processing related to the generation of a lawncare prescription. Such processing can include the processing illustrated in FIGS. 4-6, for example. The lawncare prescription application portion 113 can perform various processing related to the application of a lawncare prescription. Such application might include a lawn technician applying a prescribed product at a home or other location, for example. The processing portions of the CP 110 can provide various functionality, as described herein, based on instructions or code in the database 120.

The database 120 can include various database portions. The database 120 can include a general database 121, a product database 122, a restrictions database 123, a user database 124, and a location database 125.

The general database 121 can store various data used by and/or generated by the general processing portion 111. The product database 122 can include various data regarding products, ingredients, composition, mixture data, and other data relating to products that are processed and/or recommended by the device 100. The product database 122 can also include data or information to enable the device 100 to retrieve needed data from third-party entities. For example, ingredient data or composition data of products can be retrieved from one or more third-party entities 133, 134. For example, a composition of a particular fertilizer product can be retrieved from the company that produced such fertilizer mixture.

The database 120 can also include the restrictions database 123. The restrictions database 123 can include various data that relates to restrictions that can dictate what products can be applied to a particular location. Accordingly, the restrictions database 123 can include data that represents rules, regulations, ordinances, requirements, mandates, and other restrictions that can control what products can be applied to a particular location. For example, the restrictions database 123 might include constraints regarding how much nitrogen can be in a fertilizer that is applied to a particular location, at a particular time of the year.

The database 120 can also include the user database 124. The user database 124 can include various information regarding users of the system 10. For example, the user database 124 can include credentials that allow a user to access the system 10. The user database 124 might also include historical data of a user. Such historical data might include all the lawncare prescriptions that a particular user has created using the system 10. Accordingly, if a user assessed that a particular lawncare prescription worked well in a past job, the user might “bring up” such lawncare prescription for application in a current job.

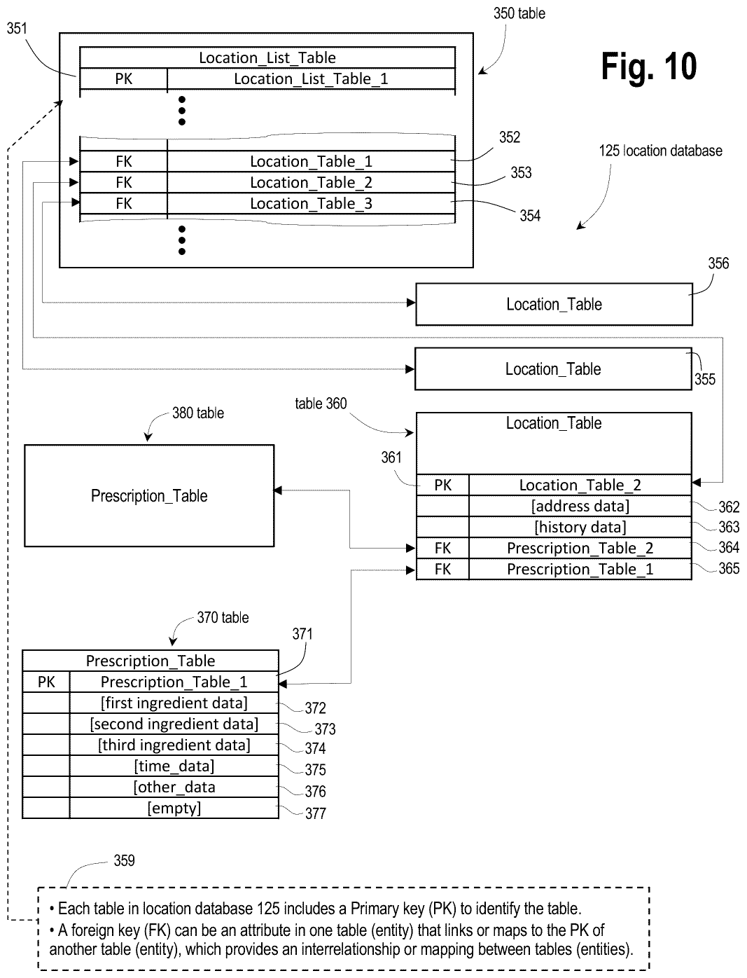

The database 120 also includes a location database 125. The location database 125 can include various information regarding locations serviced by the lawncare system 10, prescriptions that were used or applied at locations, and other related data. Details of the location database 125 are described below with reference to FIG. 10.

The system server 100 can also include a communication portion 101. The communication portion 101 can provide communication between the device 100 and external entities or components. Communication can be performed over a network 102. For example, the communication portion 101 can communicate with a restrictions database(s) 133 over the network 102. The restrictions database 133 can provide, to the device 100, the various restrictions, such as applicable regulations, that are used by the device 100. The restrictions database 133 can be in the form of one or more databases. The restrictions database 133 can be in the form of many databases spread out over, and relating to, different states, towns, cities, localities, and geographical regions, for example.

Also, the communication portion 101 can communicate with the product database(s) 134. The product database 134 can include various data relating to different products that the device 100 services. The product database 134 can also be spread over many databases. For example, the device 100 can retrieve first product data from a database of a first company, which makes a first product. The device 100 can retrieve second product data from a database of a second company, which makes a second product. The products databases 134 can include a wide variety of databases that relate to products and the compositions and/or ingredients that are used in products, for example.

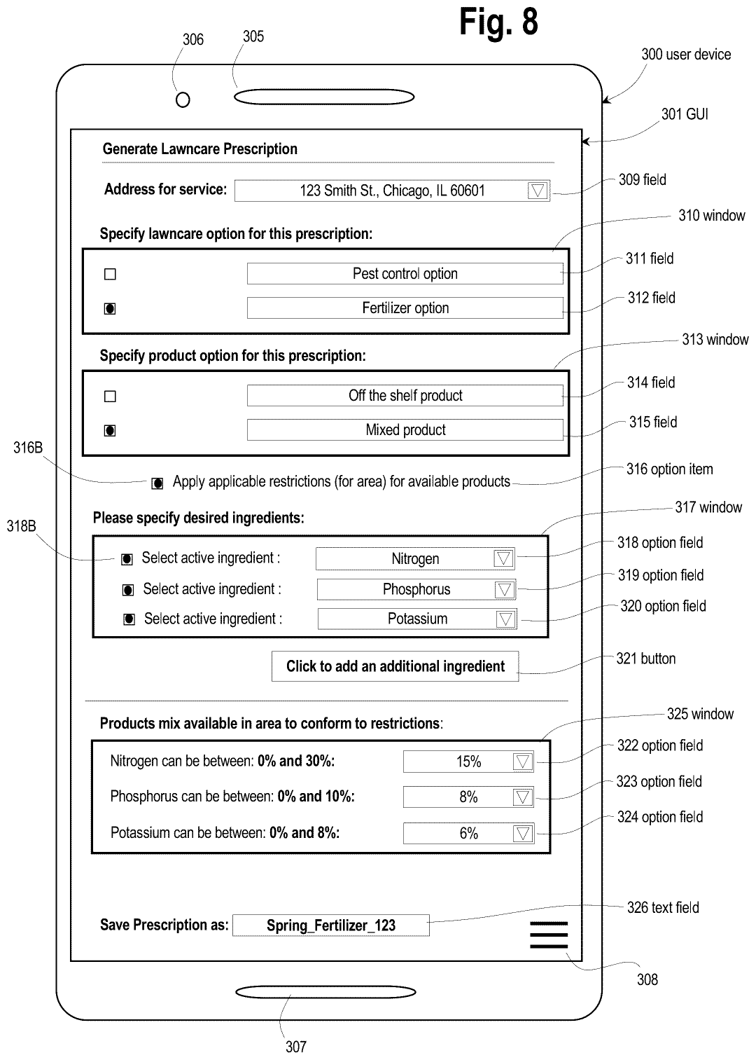

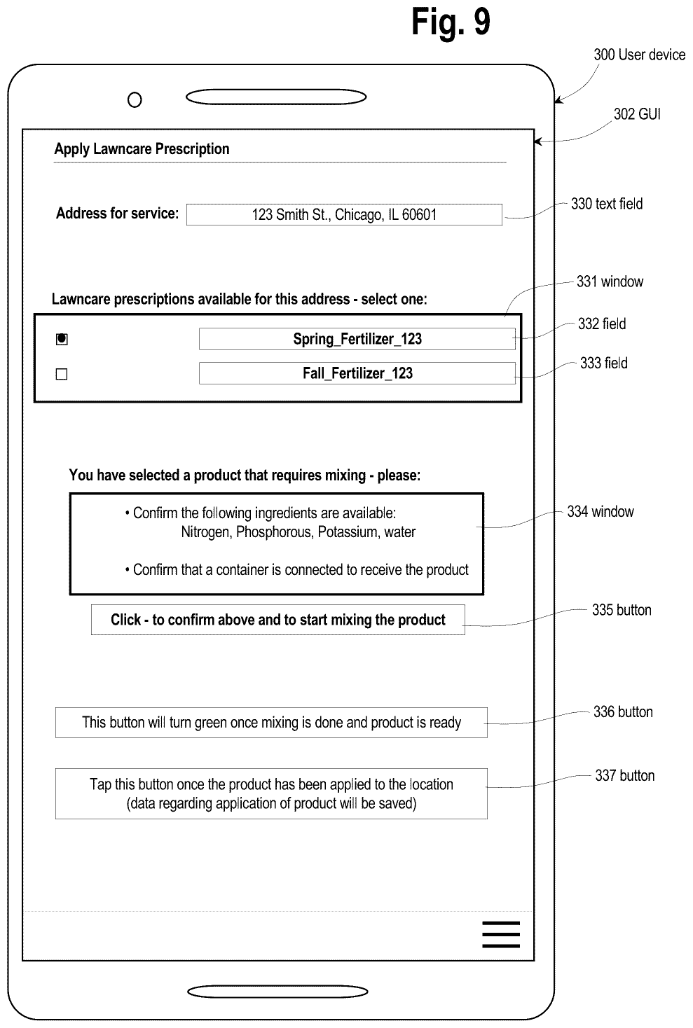

As shown in FIG. 3, the lawncare system 10 can include a first user device 131 and a second user device 132. Illustratively, the first user device 131 can be described as a user that creates a lawncare prescription, such as by using the GUI of FIG. 8. The second user device 132 can be described as a user that applies a lawncare prescription. For example, such user might utilize the GUI of FIG. 9. However, in other implementations of the system 10, the same user can both generate and apply a lawncare prescription.

FIG. 4 is a high level flowchart showing “server 100, i.e. the lawncare system 10, performs prescriptive lawncare processing” in accordance with principles of the disclosed subject matter. The processing of FIG. 4 can be initiated in step 140 and pass on to step 141.

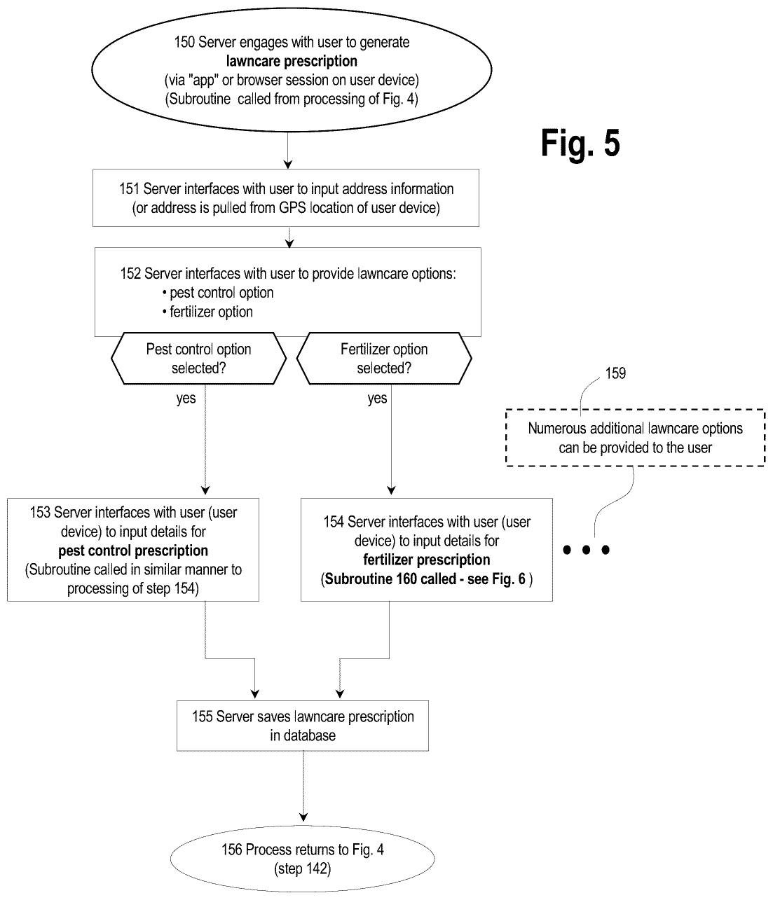

In step 141, the server 100 engages with a user to generate a lawncare prescription. Such user might be described as a first user. The server can engage with the user using a suitable interface such as an “app” or browser session on a user device. For example, the user device might be a cell phone. The GUI of FIG. 8, for example, can be generated by the server so as to interface with the user. To perform the processing of step 141, subroutine 150 can be called or invoked. Subroutine 150 is described below with reference to FIG. 5. After step 141, the process passes onto step 142.

In step 142, the server engages with a user to apply a lawncare prescription. Such user might be described as a second user. To perform the processing of step 142, the server can engage with a user using a suitable interface such as an app or browser session on user device. The GUI of FIG. 9, for example, can be generated by the server so as to interface with the user and perform the processing of step 142. To perform the processing of step 142, subroutine 180 can be called or invoked.

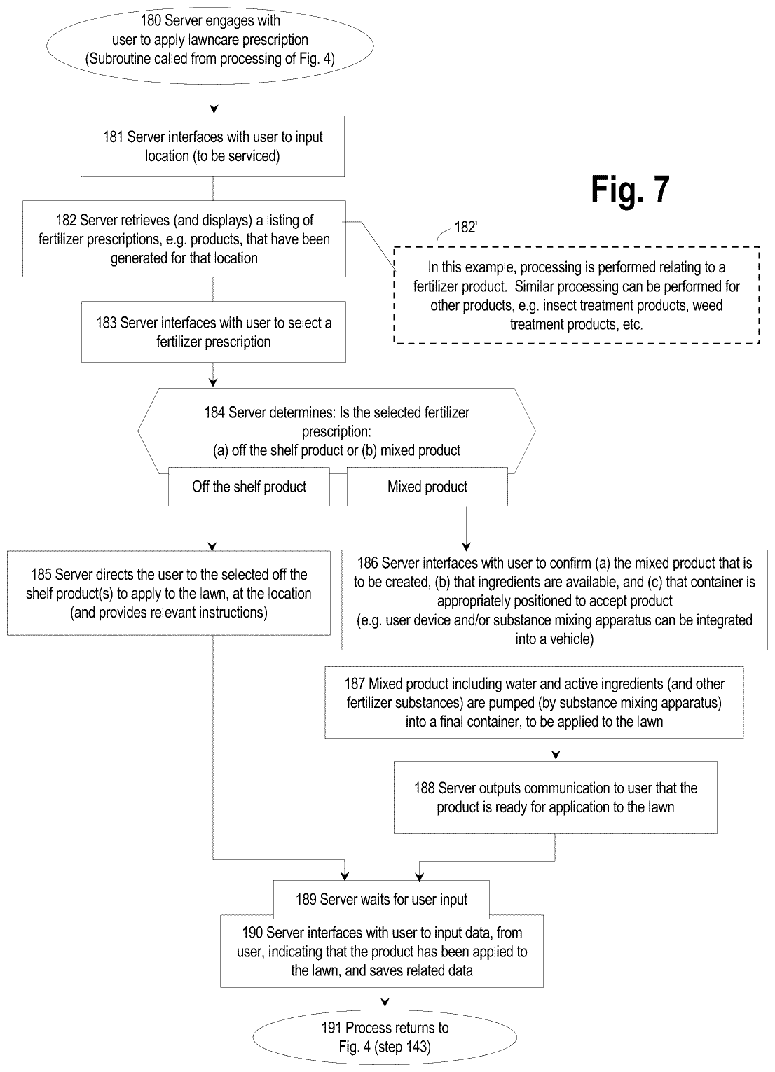

Subroutine 180 is described below with reference to FIG. 7.

For example, a second user can interface with the server in the processing of step 142. Such second user could be a technician working for a lawncare company. Alternatively, the same user can interface with the server to perform the processing of both step 141 and step 142, as reflected at 142′ in FIG. 4. For example, a property maintainer could interface with the server to generate a lawncare prescription, and at some subsequent time, the property maintainer could interface with the same user in step 142, so as to apply a product, in accord with the previously generated prescription, to the property maintainer's lawn.

After step 142, the process passes onto step 143. In step 143, the server terminates prescriptive lawncare processing. The processing of step 141 and step 142 are shown to proceed in serial manner. It is appreciated that a lawncare prescription can be generated in step 141 prior to application of that lawncare prescription in step 142. However, such processing can be performed by different users and at different times. For example, the generation of a lawncare prescription in step 141 could be performed, and then at multiple times thereafter, a lawn can be treated with the same lawncare prescription. For example, a prescription can be created once, and then such prescription can be applied to the lawn every spring thereafter, for example.

FIG. 5 is a flowchart showing “server engages with user to generate lawncare prescription” of subroutine 150, in accordance with principles of the disclosed subject matter. Such processing can include a user interfacing with the server 100 via an app or browser session on a user device, for example. Subroutine 150 can be called or invoked from the processing of FIG. 4. As shown, the process starts in step 150 and passes onto step 151. In step 151, the server interfaces with the user to input address information regarding location of the lawncare under consideration. For example, the address information can be the address of a home at which a fertilizer application will be applied. It may be the situation that the user device, of the user interfacing with the server, is actually geographically located, i.e., geo-located, at the location of the lawncare surface. In such situation, the server may be able to retrieve or pull the location from the user device. For example, a GPS location of the user device can be used to input address information in step 151. After step 151, the process passes onto step 152.

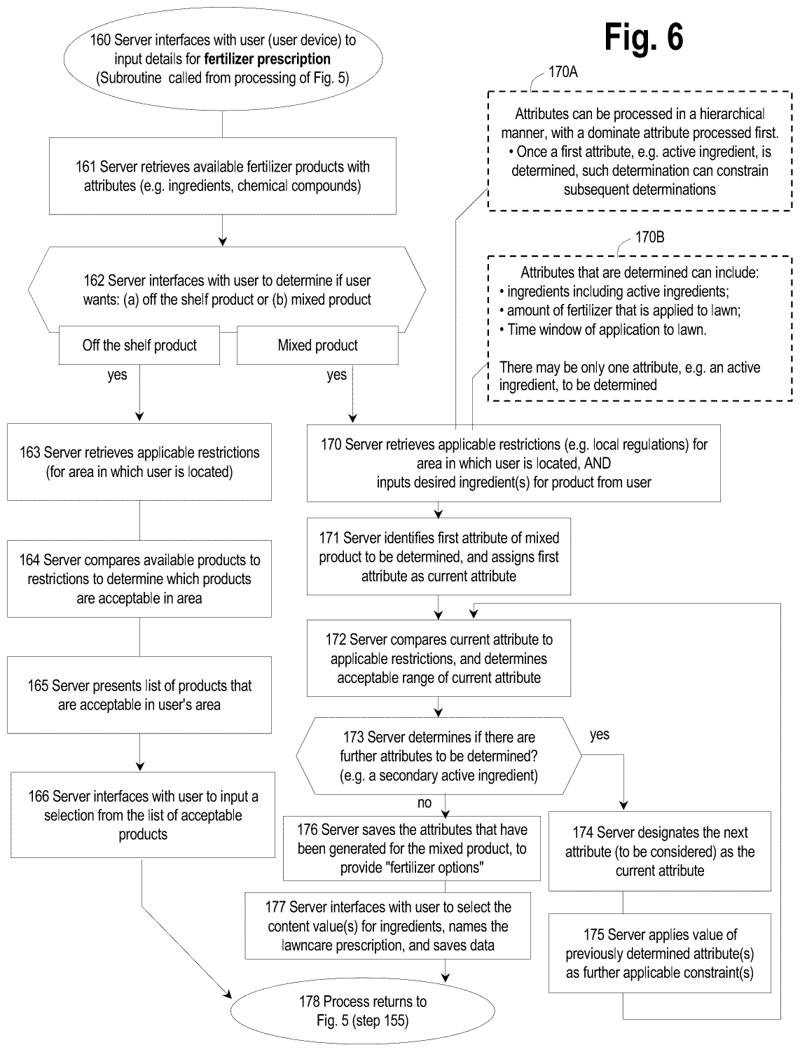

In step 152, the server interfaces with the user to provide lawncare options. Such lawncare options can include a wide variety of services. In the example of step 152, two lawncare options are provided including a pest control option and a fertilizer option. Relatedly, FIG. 8 is a schematic diagram of a user device 300. The server can communicate with the user device 300 to present a GUI 301 on the user device. The GUI 301 can be utilized in the processing of FIG. 5 and FIG. 6. For example, the GUI 301 can include option window 310. The option window 310 can be generated on the user device 300 in a browser session with the server 100. In this example, the option window 310 can provide functionality by which the user chooses between a pest control option and a fertilizer option. The server can display such options using the text field (or field) 311 and the field 312. The user can select an option by choosing one of the “radio buttons” on the left hand side of the option window 310. In the example of FIG. 8, the user has chosen the fertilizer option, as displayed in the field 312.

With further reference to FIG. 5, it may be the case that the user selects the fertilizer option. As a result, the process passes onto step 154. In step 154, the server interfaces with the user, i.e., with the user device, to input details for generation of a fertilizer prescription. To perform such processing, the server can call or invoke subroutine 160. Subroutine 160 is illustratively described below with reference to FIG. 6.

In another implementation, it may be the case that the user selects the pest control option. As a result, the process passes onto step 153. In step 153, the server interfaces with the user to input details for generation of a pest control prescription. In such processing, a subroutine can be performed in similar manner to the processing of subroutine 160. Accordingly, further details of step 153 will not be specifically described herein. As reflected at 159 of FIG. 5, it is appreciated that numerous additional lawncare options can be provided to the user. Illustratively, such additional options might include the generation of a weed control prescription or a disease control prescription, for example.

After either of step 153 or 154, the process passes onto step 155. In step 155, the server saves the lawncare prescription in a database. In particular, the lawncare prescription can be saved in location database 125. More specifically, a table or prescription table 370 can be generated that contains the data of the prescription and that is associated with the particular geographical location. Such geographical location is represented in table 360.

After step 155, the process passes onto step 156. In step 156, the process returns to FIG. 4, and illustratively passes onto step 142. However, as described above, the processing of step 141 and step 142 can be performed over a period of time. That is, step 142 might be performed days after, weeks after, or months after step 141. Also, step 142 can be repeated over a period of time.

FIG. 6 is a flowchart showing “server interfaces with user (user device) to input details for fertilizer prescription” of subroutine 160 of FIG. 4, in accordance with principles of the disclosed subject matter. Subroutine 160 can be called from the processing of FIG. 5. As shown, the subroutine starts in step 160 and passes onto step 161. In step 161, the server retrieves available fertilizer products with attributes of those products. Such attributes can include ingredients and/or chemical compounds, for example. Then, the process passes onto step 162.

In step 162, the server interfaces with the user to determine if the user wants an off-the-shelf product or a mixed product. Relatedly, the option window 313 can be generated on the user device 300 in a browser session with the server 100. The option window 313 can provide functionality by which the user chooses between an off-the-shelf product and a mixed product, as displayed in field 314 and 315, respectively, in the option window 313. The user can select an option by choosing one of the radio buttons on the left-hand side of the option window 313. In the example of FIG. 8, the user has chosen the mixed product option, as displayed in the field 315.

In step 162, if the user wants a mixed product, the processing passes onto step 163. In step 163, the server retrieves applicable restrictions for the area in which the user is located. Then, in step 164, the server compares available products to the restrictions to determine which products are acceptable in the area in which the user is located. Then, in step 165, the server presents a list of products that are acceptable in the user's area. Then, the process passes onto step 166. In step 166, the server interfaces with user to input a selection from the list of acceptable products. After step 166, the process passes onto step 178. In step 178, the process returns to the processing of FIG. 5. Specifically, the process passes onto step 155, of FIG. 5, in which the server can save the lawncare prescription in database 125.

With further reference to FIG. 6, in the processing of step 162, the server may interface with the user and determine that the user wants a mixed product. Accordingly, the processing passes onto step 170. In step 170, the server retrieves applicable restrictions for the area in which the user is located. Also, the server can input the desired ingredients or ingredients from the user. Relatedly, the option window 317 can be generated on the user device 300 in a browser session with the server 100. The option window 317 can provide functionality by which the user can choose what ingredients are to be included in the lawncare prescription. The ingredients can be input in any suitable manner. For example, the ingredients can be input using respective drop down menus as shown in the option window 317. Other mechanisms can be used to input the ingredients.

In the example of FIG. 8, the user has selected nitrogen in the option field 318, phosphorus in the option field 319, and potassium in the option field 320. In an embodiment, a user can unselect an ingredient by clicking a respective selection boxes on the left-hand side of the option window 317, as shown in the GUI 301. For example, the user can unselect or deselect the ingredient nitrogen by clicking the box 318B, i.e., so as to unselect such box 318B. Other GUI mechanisms can be used in such processing, as desired.

The GUI 301 also includes button 321. The button 321 can display “Click to add an additional ingredient”. Accordingly, the user can click the button 321 if the user wishes to be presented with additional ingredients for consideration. Upon the button 321 being clicked by the user, the option window 317 can be expanded so as to accommodate the display of such additional ingredient. However, it may be the situation that no additional ingredients are available for the particular product desired. As a result, a pop-up or other communication can be generated so as to advise the user of such status, i.e., that no further ingredients are available.

After the user chooses the ingredients in step 170, the process passes onto step 171. In step 171, the server identifies a first attribute of the mixed product to be determined. The server assigns such first attribute is the current attribute. For example, the user might select the fertilizer option in the option window 310 and that the user would like a mixed product. Based on such selection, the server can provide various ingredient options to the user. Such ingredient options can be provided in the option window 317, as shown in FIG. 8. In the processing of step 172, the server can be provided instructions regarding which ingredient to consider first. For example, the server might be provided instructions that nitrogen is the dominant ingredient, and thus should be considered first. Accordingly, in this example, the acceptable range of nitrogen, in a fertilizer product, can be the first or initial “current attribute” determined in the processing of step 171. Accordingly, in step 172, the server compares the current attribute to the applicable restrictions. The server can determine, in view of the restrictions, an acceptable range for the percentage of nitrogen in an offered fertilizer product. This acceptable range can then be displayed to the user, as shown in the option window 325, in FIG. 8. Illustratively, the acceptable nitrogen range might be 0%-30%. For example, such acceptable nitrogen range might be dictated by ordinances that are applicable to the particular location, to which the lawncare prescription will be applied.

After step 172, the process passes onto step 173. In step 173, the server determines if there are further attributes to be determined. For example, a further attribute might be the percentage of a secondary active ingredient. More specifically in this example, a further attribute might be the percentage of phosphorus of the fertilizer. Accordingly, if a yes is rendered in step 173, the process passes onto step 174. In step 174, the server designates the next attribute (to be considered) as the current attribute. Then, in step 175, the server can apply the value of the previously determined attribute or attributes as further applicable constraints.

As reflected at 170B of FIG. 6, attributes that are determined can include: ingredients including active ingredients; amount of fertilizer that is applied to a lawn; and/or time window of application to lawn. There may be only one attribute, e.g., an active ingredient, to be determined.

To explain further, it is appreciated that the server can process and assess acceptable percentages of ingredients, for example, in a hierarchical manner, as reflected at 170A in FIG. 6. An acceptable range of a dominant ingredient (for example nitrogen) can be determined first. Once an acceptable range for the initial, dominant ingredient is determined, the processing can then proceed to determination of acceptable percentages of further ingredients. Accordingly, in an embodiment of the disclosure, the acceptable percentage range of each respective ingredient, can be assessed in a predetermined order. In general, it is appreciated that there can be interrelationship between the various ingredients of a fertilizer or other lawncare composition. The interrelationship between different ingredients can depend on the particular regulation or other restriction that is applicable to the lawncare product. For example, ordinances in a first municipality may simply state that certain percentages of nitrogen, phosphorus, and potassium can be used on a property without any regard to interrelationship between such ingredients. However, ordinances in a second municipality may be based on some interrelationship between ingredients. For example, ordinances in the second municipality could dictate that if the level of nitrogen is decreased, then the level of potassium can be increased. However, the systems and methods of the invention are not limited to the hierarchical processing as described herein. Rather, other methodologies and/or mechanisms can be utilized to address interrelationships between ingredients, in a lawn care product, as needed.

At a point in the processing, the determination in step 173 will render a no value. That is, the server will determine that there are no further attributes to be determined. As result, the processing will pass onto step 176. In step 176, the server saves the attributes that have been generated for the mixed product, so as to provide fertilizer options. In the illustrative GUI 301, of FIG. 8, these fertilizer options are presented as respective ranges for nitrogen, phosphorus, and potassium. That is, the illustrative processing of steps 171-175, which can be iterative as shown, has determined that nitrogen content can be between zero and 30%, phosphorus content can be between zero and 10%, and potassium content can be between zero and 8%.

After step 176, the process passes onto step 177. In step 177, server interfaces with the user to select the content value for each ingredient using the option fields 322, 323, 324 in option window 325. In an embodiment, the option fields 322, 323, 324 can be in the form of respective drop down menus. The server may only generate values, from which the user can select, that is in the acceptable or available range presented in the option window 325. Accordingly, the drop-down menu of the option field 322 could present percentage options including: 0%, 5%, 10%, 15%, 20%, 25%, 30%, for example. More or fewer gradations could be provided. Other mechanisms can be used to display acceptable ranges of ingredients. Other mechanisms can be used to accept the user's selection of a specific ingredient percentage, as constrained by the acceptable range of each ingredients. Illustratively, in the example of option window 325, the server has determined that the acceptable range of nitrogen is between zero and 30%. Within such range, the user has chosen 15%, as displayed in the option field 322.

In some embodiments of the disclosure, the user can opt to override a suggested range that is presented in the option window 325. For example, the user might be allowed to enter 40% for the value of nitrogen in the option window 325. If the user enters a value outside the recommended range, the server can generate a communication to the user indicating such status. For example, the server might generate a pop-up that indicates that the user has selected a value of nitrogen outside the recommended range. For example, the user may have received a waiver or other adjustment to an ordinance, such that the user opts to select a value of nitrogen outside the recommended range. Relatedly, the GUI 301 can include option item 316. The option item 316 can be unselected (by the user) by clicking the box 316B, i.e., so as to uncheck such box 318B. Accordingly, if box 316B is checked, then applicable restrictions will be applied in the determination of available products. On the other hand, if box 316B is not checked, then applicable restrictions would not be applied, in an embodiment.

Step 177, of FIG. 6, can also include naming the particular prescription being created. The prescription can be named utilizing the text field 326, as shown in FIG. 8. After step 177 of FIG. 6, the process passes onto step 178. Processing then returns to the processing of FIG. 5, and proceeds as described above.

As described herein, the GUI 301, shown in FIG. 8, can provide various functionality for a user to generate a lawncare prescription. The GUI 301 can be presented on a suitable user device 300, such as a smart phone or tablet, for example. The GUI 301 can include field 309 that displays a geographical address for the service. That is, a user can interface with the GUI 301, so as to enter the applicable address into the field 309. Processing can then be performed based on the address displayed in the field 309. In particular, applicable restrictions, relating to available lawncare products, can be based on the address displayed in field 309. The field 309 can be in the form of a drop-down menu. For example, a particular user might have control over a number of locations. In particular, a lawncare professional or lawncare technician may have access to many locations. The user can be provided access all of such locations, and lawncare prescriptions that correspond to such locations, by changing the address in field 309. A user may be required to enter credentials in order to access the GUI 301 and other functionality described herein. For example, the user may be required to enter a username and password so as to access the GUI 301 of FIG. 8, as well as the GUI 302 of FIG. 9.

The GUI 301 can also include menu options 308. The menu options 308 can provide the user access to other functionality described herein. For example, the menu option 308 (in the GUI 301 of FIG. 8) could provide an option to access the GUI 302 of FIG. 9. The user device 300 can include known features, such as a speaker 305, the camera 306, a microphone 307, and other know features.

FIG. 7 is a flowchart showing “server engages with user to apply lawncare prescription” of subroutine 180, in accordance with principles of the disclosed subject matter. Such processing can include a user interfacing with the server 100 via an app or browser session on a user device, for example. Subroutine 180 can be called from the processing of FIG. 4.

Relatedly, FIG. 9 is a further schematic diagram of the user device 300. The server can communicate with the user device 300 to present a GUI 302 on the user device. The GUI 302 can be utilized in the processing of FIG. 7, as described below.

With further reference to FIG. 7, the subroutine 180 can initiate and pass onto step 181. In step 181, the server interfaces with the user to input a location to be serviced. In an embodiment, the location to the service can be based on a GPS location of the user's smart phone, for example. In an embodiment, the text field 330 can be provided in the form of a drop-down menu. The drop-down menu can be populated with all the locations associated with the particular user. Relatedly, a user may be required to enter credentials, such as username and password, so as to access the GUI 302.

After step 181, the process passes onto step 182. In step 182, the server retrieves a listing of fertilizer prescriptions, e.g., products, that have been generated for the particular location. As reflected at 182′, in this example, processing is performed relating to a fertilizer product. Similar processing can be performed for other products, e.g., insect treatment products, weed treatment products, or any other treatment as may be desired. Step 182 can also include display of the listing of fertilizer prescriptions to the user. The display of available products can be provided by option window 331, in the GUI 302. The option window 331 can include field 332 and field 333, for example. Field 332 can include a product option Spring_Fertilizer_123. Such option corresponds to the prescription illustrated in GUI 301 of FIG. 8, as reflected in the text field 326 of GUI 301. Illustratively, field 333, in the option window 331, can also provide a fall fertilizer option, that has been associated with the location shown in field 330.

After step 182, the process passes onto step 183. In step 183, the server interfaces with the user to select a fertilizer prescription. Relatedly, the user can choose one of the options, presented in the option window 331, by choosing one of the radio buttons on the left-hand side of the option window 331.

After step 183, the process passes onto step 184. In step 184, the server determines if the selected fertilizer prescription is an off-the-shelf product or a mixed product. If an off-the-shelf product has been selected, then the process passes onto step 185. In step 185, the server directs the user to the selected off-the-shelf product to apply to the lawn, at the location. The server can output relevant instructions to the user. A suitable or predetermined channel can be used to output the relevant instructions. For example, instructions can be provided in the form of a pop-up window on the user device 300. Alternatively, relevant instructions can be provided via text or email to the user. After step 185, the process passes onto step 189. In step 189, the server waits for further user input.

In step 184, the server may determine that a mixed product has been selected. As result, the process passes from step 184 onto step 186. In step 186, the server interfaces with the user to confirm (a) the mixed product that is to be created, (b) that ingredients are available, and (c) that a container is appropriately positioned to accept product. Such information can be conveyed, by the server to the user, by generation of text content in window 334, in the GUI 302 of FIG. 9. The container can be a stand-alone unit or a backpack unit, for example. The container could be integrated into a vehicle or motorized cart, for example, for application of the product onto a lawn.

For example, the user can confirm status is presented in window 334, by clicking button 335 in GUI 302. Once the status is confirmed in step 186 (by the user clicking button 335), the process passes onto step 187. In step 187, the mixed product including water and active ingredients (and other fertilizer substances) are pumped (by a substance mixing apparatus) into a container or final container, to be applied to the lawn. Then, in step 188, the server outputs a communication to the user that the product is ready for application to a lawn.

After step 188, the process passes onto step 189. In step 189, the server waits for user input. That is, in an embodiment, the user waits for confirmation from the user that the product has been applied to the lawn. Accordingly, in step 190, the server interfaces with the user to input data, from the user, indicating that the product has been applied to the lawn. The server can then save data related to application of the product on the lawn. Then, the process passes onto step 191. In step 191, the process returns to FIG. 4, and in particular, passes onto step 143 of FIG. 4. In step 143, the server terminates the prescriptive lawn care processing.

FIG. 10 is a schematic diagram of a location database 125 containing a location list table 350 and various related tables, in accordance with principles of the disclosed subject matter. The table 350 includes a reference record 351 with a primary key (PK). Such PK can be used to identify or call the table 350 in the database 120, shown in FIG. 1. As noted at 359 in FIG. 10, each table (in the location database 125) can include a Primary key (PK), in a reference record, to identify the table. As shown, some of the tables are provided with one or more foreign keys (FKs). The FK can be an attribute in one table that links or maps to the PK of another table, so as to provide an interrelationship or mapping between tables. The tables of FIG. 10 are linked as shown.

Accordingly, in addition to a reference record in each table, each table can also include a plurality of content records. The content records can include (a) the one or more foreign keys (FKs), which respectively reference another table as described above, or (b) other content.

Table 350 provides reference to various locations for which prescriptions have been generated. That is, table 350 includes references to data relating to respective locations. In particular, the table 350 includes references (FKs 352, 353, 354) to respective location tables 355, 360, 356. Various other, i.e., many more, locations can be referenced in the table 350.

Accordingly, each of the tables 355, 360, 356 contain data for a respective location for which the lawncare system 10 has received data. The tables 355, 360, 356 can have similar structure and contain similar data. Illustratively, the table 360, shown in detail, can include a reference record 361 with PK for the table 360. The PK 361 can reference back to the table 350. The table 360 can include a plurality of content records 362, 363, 364, 365.

The content record 362 can include address data of the particular location. Also, a content record 363 can include history data of the particular location. Such history data can include various data regarding past applications of lawn treatments that have been applied to the location.

The table 360 can also include content records 364, 365. The record 364 can include a FK to reference the table 380. Such table 380 can include data regarding a first prescription that has been created for the particular location.

The record 365 can include a FK to reference the table 370. Such table can include data regarding a second prescription for the location. It is appreciated that additional content records can be added, i.e., dynamically added, to the table 360 if additional prescriptions are added to the particular location. A further prescription can be added using the GUI of FIG. 8, for example.

As shown in FIG. 10, the location database 125 includes the table 370. The table 370, i.e., a prescription table, contains data regarding a prescription associated with a location represented in table 360. The table 370 can include a PK, in reference data record 371, which can be referenced by the FK in data record 365 of table 360.

The table 370 can include various data that is associated with a respective prescription. In particular, the table 370 can include first ingredient data in data record 372. The table 370 can include second ingredient data in data record 373, as well as third ingredient data in data record 374. This data can be populated in the table 370 through interfacing with a user via the GUI 301 of FIG. 8. For example, the ingredients in data records 372, 373, 374 might represent the ingredients shown in option window 325 in the GUI of FIG. 8.

The table 370 can also include other data relating to the particular prescription. For example, the table 370 can include time data, in data record 375, that includes data regarding past applications of the prescription. Any other data can be saved in the table 370 (in data record 376), and the other data structures of FIG. 10, as may be desired. A data record 377 can be empty or null prior to being populated with data, such as data relating to suggested periodicity of repeat applications, for example. The table 380 can be populated with data in similar manner to the table 370, with the table 380 containing data that relates to second prescription, as represented in data record 364 in table 360.

In processing of the location database 125, data set forth in the various tables of the location database 125 can be retrieved by a call, by server 100, to the particular table, which specifies the particular record, field and/or member within the particular table. Also, in processing, data can be written to a particular table by outputting the data to the particular table, and specifying the particular record, field and/or member (within the particular table) to which the data should be written, for example. It is appreciated that data, as described herein, may be stored in a database, retrieved from a database, and/or otherwise manipulated using known computer processing techniques. Further, it is appreciated that various additional data can be included in any of the tables shown in FIG. 10, including any of the data described herein.

### Alternative Embodiments

While certain embodiments of the invention are described above, it should be understood that the invention can be embodied and configured in many different ways without departing from the spirit and scope of the invention.

The prescriptive lawn care (PLC) system 10 can include a control center or user device 131 configured for prescribing, visualizing, purchasing, scheduling, and controlling various aspects of lawn or turf care. For example, the PLC 10 can include various sensors, including moisture/water sensor(s), color sensor(s), soil acidity (pH) sensor(s), turf density sensor(s), compaction sensor(s), turf height sensor(s), pattern sensor(s), as well as other sensors. The sensors can include cameras, thermocouples, tensiometric sensors, volumetric sensors, time domain reflectometry sensors, gypsum bock sensors, as well as other known sensors for inputting information to the system 10.

The prescriptive lawn care (PLC) system 10 can be a total solution for optimal lawn care that minimizes effort and resources required to care for lawn and turf. The system 10 can provide an environmental solution to lawn and turf care via a cell phone or computer app or software installed on a controller for a lawn or turf care machine.

The prescriptive lawn care (PLC) system 10 can be configured for intelligent control or management of a number of assets in connection with yard or turf maintenance with the assistance or inclusion of a management unit having distributed properties. Thus, for example, sensor equipment and task performance equipment operation may be coordinated between local management and remote management entities for efficient monitoring and maintaining of lawn and turf wellness. In some embodiments, Bluetooth, Wi-Fi or other short range wireless communication modules may be used to communicate data to an intermediate device (e.g., a cell phone), which may then communicate the data to a computer or other device at which certain analysis and/or display may be performed.

The prescriptive lawn care (PLC) system 10 can also be configured to provide or create a digital twin of a particular lawn or turf area. Frequent and infrequent data sources can be combined in a digital profile of the target lawn. The digital profile can include two types of information: general data (climate, soil sample data, etc.) and geo located data (grass density, grass color, grass variety, moisture level, disease and weed location, localized ambient light, localized soil density, etc.). The boundaries of the lawn are established using a precision mapping tool, and geo location data may be visualized as an overlay to a map on the user device 131. The digital lawn can be utilized to develop a treatment plan, including local emphasis treatment in specific areas only which may be used directly by a user, or shared with service providers that may complete the task. Digital lawn data can be input and output in a standard format which makes it easy for many information sources to contribute to the digital lawn (landscapers, neighbors, other equipment manufacturers), and also allows many providers to utilize the lawn date (equipment companies, landscapers, fertilizer companies, etc.). The regular inputs into the system 10 can include weather data, data from sensors (as noted above, including cameras, etc.), data from homeowner equipment, data from neighbors' equipment, data from professional landscaper equipment. The less frequent data inputs into the system 10 can include law scan and mapping information, geographic information including soil and climate information, soil sample analysis, etc. Using all of this data, the system 10 can make product and service recommendations related to the lawncare equipment associated with the system (lawnmower, trimmer, spreader, cutters, etc.). The system 10 could generate sales leads based on the sensed or input data that are communicated to manufacturers of lawncare equipment, fertilizer companies, lawncare equipment rental companies, landscapers, etc. In this version of the system, the lawncare equipment, associated controllers, and sensors, can form an Internet of Things that communicate with each other and to external entities to achieve an efficient system that can provide environmental benefits through inherent efficiencies of the collaborative work product. The system 10 can effect a stocking policy, a logistics policy, a product recommendation policy, a maintenance reminder policy and a directed marketing policy.

The system 10 can include a vehicle for delivering lawncare fertilizer mixtures, comprising: a steering mechanism; an ambulation device such as wheels; a storage compartment including a plurality of lawncare substances including at least a first fertilizer substance and a second fertilizer substance; a controller configured to mix at least one of a ratio and a selection of the plurality of lawncare substances based on a location of the vehicle.

The system 10 can also include a substance mixing apparatus configured to place the ratio of the selected substances into a final container for disbursement to a lawn. The substance mixing apparatus can include a pump connected to the storage compartment and configured to draw at least one of the plurality of substances into the final container. The substance mixing apparatus can also include an auger configured to draw at least one of the plurality of substances into the final container.

The substance mixing apparatus can include an auger configured to draw at least one of the plurality of substances into the final container.

The ambulation device can include a motor connected to drive at least one of the plurality of wheels.

The vehicle can include a controller having a memory, and the memory includes a database in which local regulations related to lawncare fertilizers are stored. The controller can include structure for connecting to the internet, and the controller can be configured to obtain local regulations related to lawncare fertilizers from an internet source based on the location of the vehicle.

The vehicle can be configured as one of a lawn tractor, a push lawncare device without motor, and a service vehicle including at least one of an electric engine, a hybrid electric/internal combustion engine, and an internal combustion engine.

Another exemplary system 10 can include a vehicle 1500 for delivering lawncare fertilizer mixtures. The vehicle can include a steering mechanism, an ambulation device, a first fertilizer substance container, a second fertilizer substance container, a mixing apparatus configured to mix a first fertilizer located in the first fertilizer substance container with a second fertilizer located in the second fertilizer substance container to create a mixed fertilizer substance, and to deliver the mixed fertilizer substance to one of a final container and a lawn upon which the vehicle travels, a controller configured to operate the mixing apparatus based on a location of the vehicle. The vehicle can include a GPS location device configured to provide location information to the controller. The mixing apparatus can include at least one pump connected to at least one of the first fertilizer substance container and the second fertilizer substance container. The mixing apparatus can include at least one auger device connected to at least one of the first fertilizer substance container and the second fertilizer substance container. The controller can include at least one of: a memory, and the memory includes a database in which local regulations related to lawncare fertilizers are stored, and structure for connecting to the internet wherein the controller is further configured to obtain local regulations related to lawncare fertilizers from an internet source based on the location of the vehicle.

A method for providing a location specific mixture of fertilizer, can include: providing a first fertilizer substance container; providing a second fertilizer substance container; obtaining information related to location of the first fertilizer substance container and second fertilizer substance container; obtaining information related to local regulations for using the first fertilizer substance and the second fertilizer substance; mixing the first fertilizer substance with the second fertilizer substance in accordance with the information related to local regulations to create a mixed fertilizer substance; and applying the mixed fertilizer substance to a lawn at the location of the first fertilizer substance container and second fertilizer substance container.

The above noted method can include: providing an ambulatory lawncare device; providing an application for use with a cellular phone; and providing a controller configured to communicate with the application on the cellular phone device, wherein obtaining information related to location of the first fertilizer substance container and second fertilizer substance container is achieved using the application for use with the cellular phone, and obtaining information related to local regulations for using the first fertilizer substance and the second fertilizer substance is achieved using the application for use with the cellular phone.

As described herein, in at least some embodiments of the system of the disclosure, various processes are described as being performed by one or more computer processors. Such one or more computer processors can, in conjunction with a database or other data storage mechanism, provide and/or constitute a “processing machine,” i.e., a tangibly embodied machine, in that such one or more computer processors can include various physical computing devices as otherwise described herein, various support structure to physically support the computing devices, other hardware, and other physical structure, for example. In embodiments, a processing machine of the disclosure can include one or more computer processors and one or more databases that are in communication with the one or more computer processors. A computer processor or processing machine of the disclosure can be part of a higher level system or apparatus.

As used herein, the term “computer processor” can be understood to include at least one processor that uses at least one memory. The at least one memory can store a set of instructions. The instructions may be either permanently or temporarily stored in the memory or memories of the processing machine or associated with the processing machine. The computer processor can execute the instructions that are stored in the memory or memories in order to process data, input data, output data, and perform related processing. The set of instructions may include various instructions that perform a particular task or tasks, such as any of the processing as described herein. Such a set of instructions for performing a particular task may be described as a program, software program, code or simply software. Accordingly, various processing is described herein as performed by a computer processor (CP). Such computer processor (CP) can be described as or can include: a computer processor portion, a computer processing portion, a processor, a system processor, a processing system, a server, a server processing portion, an engine, a processing engine, a central processing unit (CPU), a controller, a processor-based controller, an electronic computing device, an apparatus controller, an apparatus computer processor, a processing device, a computer operating system, an apparatus processing portion, an apparatus processing portion, an electronic control unit (“ECU”), a microcontroller, a microcomputer, a plurality of electronic computing devices or servers, other processor-based controller(s), and/or similar constructs, for example.

A computer processor and/or processing machine, of the disclosure, may be constituted by and/or be part of particular apparatus(es), system(s) and/or device(s) described herein. The computer processor can execute instructions that are stored in memory or memories to process data. This processing of data may be in response to commands by a user or users of the computer processor, in response to previous processing, in response to a request by another processing machine and/or any other input, for example. A user can be in the form of a user device, such as a cellular phone.

A computer processor and/or processing machine of the disclosure may also utilize (or be in the form of) any of a wide variety of technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that can be capable of implementing the steps of the processes of the disclosure.

The computer processor and/or processing machine used to implement the disclosure may utilize a suitable operating system. Thus, embodiments of the disclosure may include a processing machine running the Windows 11 operating system, the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the disclosure as described herein, it is not necessary that the computer processors and/or the memories of a processing machine be physically located in the same geographical place. That is, each of the computer processors and the memories used by the processing machine may be located in geographically distinct locations and connected so as to communicate in any suitable manner. Additionally, it is appreciated that each computer processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above can be performed by various components and various memories. However, it is appreciated that the processing performed by two distinct components as described herein may, in accordance with a further embodiment of the disclosure, be performed by a single component. Further, the processing performed by one distinct component as described above may be performed by two distinct components. For example, processing as described herein might be performed in part by a system or other system or server, in part by some third party resource, and in part by a user device. In a similar manner, the memory storage performed by two distinct memory portions as described herein may, in accordance with a further embodiment of the disclosure, be performed by a single memory portion. Further, the memory storage performed by one distinct memory portion as described above may be performed by two memory portions.

Further, as described herein, various technologies may be used to provide communication between the various processors and/or memories, as well as to allow the processors and/or the memories of the disclosure to communicate with any other entity; i.e., so as to obtain further instructions, transfer data, or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described herein, a set of instructions can be used in the processing of the disclosure on the processing machine, for example. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It is appreciated that the instructions or set of instructions used in the implementation and operation of features of the disclosure may be in a suitable form such that a computer processor or processing machine may read the instructions. For example, the instructions that form a program may be in the form of a suitable programming language, which can be converted to machine language or object code to allow the processor or processors to read the instructions. That is, written lines of programming code or source code, in a particular programming language, can be converted to machine language using a compiler, assembler or interpreter. The machine language can be binary coded machine instructions that are specific to a particular type of processing machine, i.e., to a particular type of computer processor, for example. The computer processor understands the machine language.

Accordingly, a suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, Python, Ruby, PHP, Perl, JavaScript, and/or other scripting language, for example. Further, it is not necessary that a single type of instructions or single programming language be utilized in conjunction with the operation of the systems and methods of the disclosure. Rather, any number of different programming languages may be utilized as may be necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example. Accordingly, a compression or encryption technique or algorithm can be used that transforms the data from an un-encrypted format to an encrypted format.

As described above, the disclosure may illustratively be embodied in the form of a processing machine, including a computer processor, for example, that includes at least one memory. It is to be appreciated that the set of instructions, i.e., the software for example, that enables the computer processor to perform the operations described herein may be contained on any of a wide variety of media or medium, as desired. Further, the data that can be processed by the set of instructions can be contained on any of a wide variety of media or medium. That is, the particular medium, i.e., the memory or data storage device used in a processing machine, utilized to hold the set of instructions and/or the data used in practice of the disclosure may take on any of a variety of physical forms or transmissions, for example. Illustratively, the medium or data storage device may be in a tangibly embodied form of paper, paper transparencies, a compact disk, a DVD, an integrated circuit, a hard disk, a floppy disk, an optical disk, a magnetic tape, a RAM, a ROM, a PROM, a EPROM, a CD-ROM, a DVD-ROM, a hard drive, a magnetic tape cassette, a wire, a cable, a fiber, communications channel, and/or may be in the form of a satellite transmissions or other remote transmission, as well as any other medium or source of data that may be read by the processors of the disclosure.

For example, exemplary embodiments are intended to cover all software or computer programs capable of enabling processors to implement the operations, designs and determinations as described herein. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed herein.

These computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs and outputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. A network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The database(s), memory or memories used in the processing machine that implements the disclosure may be in any of a wide variety of forms to allow the memory to hold instructions, data, or other information, as can be desired. Thus, a memory might be in the form of a database to hold data. The database might use any desired arrangement of files or data sets such as a flat file arrangement or a relational database arrangement, for example. The database can include any number of data records, tables, and/or other data structure. A table in a database can include a Primary key (PK) to identify the table. A foreign key (FK) can be an attribute in one table (entity) that links or maps to the PK of another table, so as to provide an interrelationship or mapping between tables and/or databases, for example.

In various processing described herein and illustrated by flowcharts or otherwise described, variables can be used in various processes. Such processes can include routines, subroutines, and steps, for example. The various variables can be passed between processes as may be needed in accord with the instructions provided to a processor. The various variables can be global variables that are available to the various processes, such as between a calling process and a subroutine, for example.

In the system and method of the disclosure, a variety of “user interfaces” may be utilized to allow a user to interface with the processing machine or machines that are used to implement the disclosure. As used herein, a user interface can include any hardware, software, or combination of hardware and software used by the processing machine that allows a user to interact with the processing machine and/or computer processor. A user interface may be in the form of a dialogue screen for example. A user interface may also include any of a mouse, touch screen, keyboard, voice reader, voice recognizer, dialogue screen, menu box, list, checkbox, toggle switch, a light, a pushbutton or any other device that allows a user to receive information regarding the operation of the processing machine as the processing machine processes a set of instructions and/or provide the processing machine with information. Accordingly, the user interface can be any device that provides communication between a user and a processing machine and/or computer processor. The information provided by the user to the processing machine through the user interface may be in the form of a command, a selection of data, or some other input, for example.

A user interface of the disclosure can be provided by or in the form of a user device or electronic user device. Also, systems of the disclosure can include or be in communication with one or more user devices that serve to interact or interface with a human user. A user device can be any appropriate electronic device, such as a cellular (mobile) telephone, smart phone, a tablet computer, a laptop computer, a desktop computer, an e-reader, an electronic wearable, smartwatch, gaming console, personal digital assistant (PDA), portable music player, fitness trackers with smart capabilities, and/or a server terminal, for example.

Such a user device can permit a user to input requests for information, output information, and/or process data. A user device can be in the form of and/or include a computer processor and/or a processing machine, as described herein.

As discussed above, a user interface can be utilized by the processing machine, which performs a set of instructions, such that the processing machine processes data for a user. The user interface can be typically used by the processing machine for interacting with a user either to convey information or receive information from the user. However, it should be appreciated that in accordance with some embodiments of the systems and methods of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be described as a user. Further, it is contemplated that a user interface utilized in the systems and methods of the disclosure may interact partially with another processing machine or processing machines, while also interacting partially with a human user.

Features as disclosed herein may be described in context of particular units or dimensions. It is appreciated that alternative units or dimensions can be used as desired. Additionally, conversion can be performed between units or dimensions as may be desired.

In this disclosure, quotation marks, such as with the language “computer processor”, have been used to enhance readability and/or to parse out a term or phrase for clarity.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, process step, region, layer or section from another region, layer or section. Thus, a first element, component, process step, region, layer or section could be termed a second element, component, process step, region, layer or section without departing from the teachings of the present disclosure.

Spatially and organizationally relative terms, such as “lower”, “upper”, “top”, “bottom”, “left”, “right”, “north”, “south”, “east”, “west”, “up”, “down”, “right”, “left”, “upper threshold”, “lower threshold” and the like, may be used herein for ease of description to describe the relationship of one element or feature to another element(s) or feature(s) as illustrated in the drawing figures. It will be understood that spatially and organizationally relative terms are intended to encompass different orientations of or organizational aspects of components in use or in operation, in addition to the orientation or particular organization depicted in the drawing figures. For example, if a device or apparatus in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

Embodiments are also intended to include or otherwise cover methods of using and methods of manufacturing any and all of the elements disclosed above.

As used herein, “data” and “information” have been used interchangeably.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, process steps, operations, elements, and/or components, but do not preclude the presence or addition of one or more other features, integers, process steps, operations, elements, components, and/or groups thereof.

Embodiments of the disclosure are described herein with reference to diagrams, flowcharts and/or other illustrations, for example, that are schematic illustrations of idealized embodiments (and intermediate components) of the disclosure. As such, variations from the illustrations are to be expected. Thus, embodiments of the disclosure should not be construed as limited to the particular organizational depiction of components and/or processing illustrated herein but are to include deviations in organization of components and/or processing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

While the subject matter has been described in detail with reference to exemplary embodiments thereof, it will be apparent to one skilled in the art that various changes can be made, and equivalents employed, without departing from the scope of the disclosure.

All references and/or documents referenced herein are hereby incorporated by reference in their entirety.

It will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

1. An automated system for delivering fertilizer to a property, comprising:
at least one of a lawncare machine and lawncare tool including a cargo space configured to deliver fertilizer to the property; and
a controller configured to,
communicate with a database that includes regulations related to fertilizer and associated with a location of the property,
present to a user a list of authorized fertilizer products based on the location of the property and the regulations.

2. The automated system for delivering fertilizer to a property according to claim 1, wherein the controller is a user device that includes a graphic user interface.

3. The automated system for delivering fertilizer to a property according to claim 1, further comprising:
a server; and
a second user device that includes a graphic user interface and is configured to communicate information related to fertilizer products to the server, wherein the user device is also configured to communicate information related to fertilizer products to the server.

4. The automated system for delivering fertilizer to a property according to claim 1, further comprising:
a server; and
a location sensor configured to determine a geographical location of the at least one lawncare machine and lawncare tool,
wherein the controller is configured to send information related to location and amount of fertilizer applied at the location to the server.

5. The automated system for delivering fertilizer to a property according to claim 4, wherein the server is configured to compile data received over time from the controller related to amount and location of application of fertilizer, and present to the user a list of authorized fertilizer products and authorized amounts of fertilizer products based on the data.

6. The automated system for delivering fertilizer to a property according to claim 1, wherein the controller is configured to send a purchase request to a third party facility in response to a user selecting at least one fertilizer product from the list of authorized fertilizer products.

7. A system to assess lawn fertilizer conditions at a location, the system including a tangibly embodied computer processor (CP) and a tangibly embodied database, the CP implementing instructions on a non-transitory computer medium disposed in the database, and the database in communication with the CP, the system comprising:
a communication portion for providing communication between the CP and a user device;
the database that includes the non-transitory computer medium, and the database including the instructions, and the database storing advice/regulation data regarding fertilizer;
a location sensor that generates sensor location data based on physical location; and
the CP, and the CP performing processing including:
determining that a first sample event has been attained;
inputting, based on the determining that the first sample event has been attained, first sample data relating to a first sample, and the first sample data including first location data and first advice/regulation data, (a) the first location data representing where the first sample was taken, and, (b) the first advice/regulation data including information related to fertilizer,
the first location data is part of the sensor location data, and the information related to fertilizer is part of the advice/regulation data;
identifying, based on the first location data, information related to fertilizer associated with the first location data; and
applying the information related to fertilizer associated with the first location data to an operation for the location.

8. The system of claim 7, wherein the operation includes mixing at least two ingredients to create a fertilizer substance in compliance with the advice/regulation data corresponding to the first location data.

9. The system of claim 8, wherein the operation includes placing the fertilizer substance onto a lawn at a place corresponding with the first location data.

10. The system of claim 8, wherein the first location data including a Global Positioning System (GPS) location;
the database storing a grid map that includes a plurality of grid areas that segregate the location, and the location being a piece of land, wherein the boundaries of a first grid area of the plurality of grid areas are defined by a first latitude value, a second latitude value, a first longitude value, and a second longitude value.

11. (canceled)

12. The system of claim 8, the system including at least one of a lawncare machine and a lawncare tool for working the location, and the location sensor is integrated with the at least one of a lawncare machine and a lawncare tool,

13. (canceled)

14. The system of claim 7, wherein the user device is at least one selected from the group consisting of a computer, a cell phone, and a tablet.

15. A method for fertilizing a property, comprising:
providing a user device that includes a graphic user interface;
at least one of determining and inputting, via the user device, a location of the property;
accessing, via the user device, a database that includes regulations related to fertilizer and associated with the location of the property;
compiling and presenting to a user, via the user device, information related to authorized fertilizer products based on the regulations and location of the property.

16. The method for fertilizing a property as set forth in claim 15, further comprising:
purchasing, by the user via the user device, at least one fertilizer product that is included in the list of authorized fertilizer products.

17. The method for fertilizing a property as set forth in claim 16, further comprising:
shipping to the property the at least one fertilizer product that is purchased via the user device.

18. The method for fertilizing a property as set forth in claim 15, further comprising:
providing at least one of a lawncare machine and a lawncare tool in which the user device is incorporated;
providing instructions, via the user device, related to lawncare based on the information related to authorized fertilizer products and based on the regulations and location of the property; and
treating the property with at least one of the lawncare machine and lawncare tool in accordance with instructions.

19. The method for fertilizing a property as set forth in claim 15, further comprising:
providing a second user device;
providing a server;
compiling, via the server, information related to amount and location of fertilizer applied to the property from each of the user device and second user device.

20. The method for fertilizing a property as set forth in claim 15, further comprising:
providing a server;
compiling, via the server, information related to amount and location of fertilizer applied to the property from the user device.
